(19) United States
(12) Patent Application Publication
(10) Pub. No.: US 2008/0181585 A1
(43) Pub. Date: Jul. 31, 2008

(54) System and Method for Allocating Excess Capacity on a Storage Medium

(75) Inventors: Frank Bryant, South Pasadena, CA (US); Christopher T. Carey, Santa Clarita, CA (US)

Correspondence Address: THE WALT DISNEY COMPANY;C/O GREENBERG TRAURIG LLP, 2450 COLORADO AVENUE SUITE 400E, SANTA MONICA, CA, 90404, US

(73) Assignee: Disney Enterprises, Inc.

(21) Appl. No.: 11/627,747

(22) Filed: Jan. 26, 2007

(51) Int. Cl. H04N 5/00

(52) U.S. Cl. 386/126

(57) ABSTRACT

A system and method is provided for identifying and allocating excess storage capacity on a storage media. Primary content is identified to be stored on the storage medium, whereby secondary content is allocated to be stored in the excess capacity of the storage medium that is not required for the primary content. The secondary content that is allocated to the excess capacity of the storage medium is selected so as to occupy the full storage capacity of the storage medium. The allocated secondary content may comprise advertisements, such that the excess capacity of the storage medium can be sold to advertisers to have their advertisements included as the secondary content stored on the storage medium.

### TECHNICAL FIELD

This disclosure relates generally to the field of multi-media storage devices and, more particularly, to a system and method for allocating excess capacity for additional content on storage media.

### BACKGROUND

Multimedia content, such as a movie, is typically sold and distributed to consumers on a portable data storage media. Optical disc storage media formats are prevalently used for the distribution and playback of movies with high video and sound quality and for storing data. Examples of optical storage media include CDs, CD-ROMs, laser disks, DVDs (“digital versatile disks” or “digital video disk”). Typically, the content stored on a DVD includes the main piece of multimedia content, such as a movie, along with additional pieces of contents such as an FBI copyright warning followed by one or more “previews” (also called “trailers”) of upcoming theatrical movies or video releases. More recently, it has also become commonplace for movie DVDs to include additional content, such as deleted scenes that were not included in the theatrical release or commentary from the director of the movie.

The amount of content that is stored on a storage media is restricted by the storage capacity of such storage media and the data compression used. For instance, a single-layer DVD is capable of storing 4.7 GB of data, enough for a full-length movie, while dual-layer DVDs can store 8.5 GB and double-sided DVDs can store 9.4 GB for single layer and 17 GB for dual-layer disks. To fit more content on a fixed size disk it is possible to adjust data compression characteristics although aggressive data compression may affect fidelity of the recording.

Commercial DVD (e.g., DVD-Video) content development has three basic stages: encoding, authoring (design, layout, and testing), and premastering (formatting a disc image). The entire development process is sometimes referred to as authoring. During the conventional authoring process, content is allocated to a DVD only if the DVD has sufficient storage capacity for the allocated content, where a simple determination is made as to whether or not the content will fit or not. Commercial DVD movies are encoded using a combination of MPEG-2 compressed video and audio of varying formats. Due to the large number of individual video and audio elements that comprise a typical DVD-Video release and further due to the variable bit rates that can be used in the video compression technology, it is a regular practice in the DVD authoring industry to allocate a “buffer” or “cushion” when planning the content for the overall DVD to avoid a “Does Not Fit” condition when writing to the DVD where the content to be stored exceeds the storage capacity of the DVD. Thus, when the DVD authoring process is complete, there typically remains unused capacity on every commercial DVD based on the DVD authoring and production process. This unused capacity is typically left empty, thereby resulting in millions of DVD discs being delivered into consumers' homes with unused capacity.

### SUMMARY

According to a feature of the disclosure a system and method is provided for identifying and allocating excess storage capacity on a storage media. In one aspect, storage medium capacity is allocated by determining the storage conditions for primary content to be stored on a storage medium and allocating secondary content to be stored in the excess capacity of the storage medium that will not be occupied by the primary content. The secondary content is allocated to the excess capacity of the storage medium in order to more completely occupy the capacity of the storage medium with both the primary and secondary content

In another aspect, the determined storage conditions for the primary content can be affected by the allocated secondary content. For instance, the primary content may be stored on the storage medium according to a variably selectable rate of compression, such that both a rate of compression to be selected for the primary content and the secondary content to be allocated to the excess capacity may be taken into consideration so as to more completely occupy the available storage capacity of the storage medium.

In another aspect, the storage medium is an optical storage media, such as a DVD, where the storage conditions for the primary content are determined and the secondary content is allocated at a final compilation and disc rendering stage in a DVD authorizing process.

In a further aspect, the manner in which secondary content is allocated to the excess capacity of the storage medium based upon at least one input selected from the group consisting of a number of secondary content files, compression rates of either the primary or secondary content, storage capacity available on the storage medium, amount of secondary content, value of secondary content, projected unit volume production for the storage medium, desired playback device for the storage medium and price of the storage medium.

In one aspect, the allocated secondary content are advertisements, where the excess capacity of the storage medium can be sold to advertisers to have their advertisements included as the secondary content stored on the storage medium. In this manner advertising can be delivered to consumers using the otherwise unused bandwidth capacity available on mass-distributed storage media that are delivered to consumers.

### DRAWINGS

The above-mentioned features and objects of the a present disclosure will become more apparent with reference to the following description taken in conjunction with the accompanying drawings wherein like reference numerals denote like elements and in which:

FIG. 1 is a flow diagram of a method for allocating excess capacity on a storage medium in accordance with one embodiment of the present disclosure.

FIG. 2 is a block schematic representation of allocating capacity for primary and secondary content on an exemplary storage medium.

FIG. 3 is a block schematic diagram of a system for allocating excess capacity on a storage medium in accordance with one embodiment of the present disclosure.

### DETAILED DESCRIPTION

The present disclosure involves a system and method for allocating excess capacity for additional content on a storage media. In the following description, numerous embodiments are set forth in order to provide a thorough understanding of the invention. It will be apparent, however, to one skilled in the art, that these and other embodiments may be practiced without these specific details. In other instances, well-known features have not been described in detail in order not to obscure the invention.

The present system and method can be implemented using any type of storage media. Examples include, without limitation, floppy disk drives, hard disk drives, RAM cards, CDs and CD-ROMs, laser disks, VCDs (“video CDs”) and DVDs (“digital versatile disks” or “digital video disks”), HD DVDS, Blu-ray disc® technology, EVDs, FVDs, digital tapes, flash drives, and other digital portable memory.

One embodiment uses a DVD as the storage medium. In this embodiment, the DVD contains primary content, such as a motion picture, stored thereon as well as secondary content, such as advertisements, supplemental movie content, movie trailers, etc. In other embodiments, other types of primary and secondary content may include musical recordings, computer software (including computer games, simulations and virtual environments), video recordings, multi-media programs, marketing content, executable files, hyperlinks, electronic forms, stamps, public service announcements, collectable cards, coupons, etc.

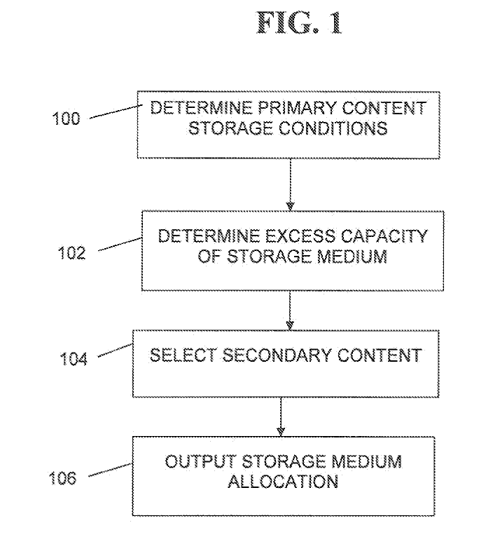

Referring now to FIG. 1, an operational flow diagram for one embodiment of a method of allocating excess capacity for additional content on a storage media is illustrated. The storage conditions for the primary content to be stored on the storage medium are determined in operation 100. The storage conditions may include, without limitation, the possible rates of compression for the primary content, the amount and/or size of the primary content, the location on the storage medium where primary content is to be stored, the type of data containing the primary content, etc. In the example of a motion picture stored on a DVD as the primary content, the storage conditions for the motion picture may include the particular type of video and audio compression used as well as the variable bit rate (VBR) of the video compression. The variable bit rate of the video compression may differ between any two pieces of primary content. For instance, the maximum desirable compression for an action movie may be less than the maximum desirable compression allowed for a drama movie.

After or in conjunction with the determination of the primary content storage conditions, the secondary content is allocated to the remaining excess capacity of the storage medium that is not required for the storage of the primary content. In operation 102, the remaining excess capacity of the storage medium that would be available in excess of the capacity required for the storage of the primary content is determined. The excess capacity determination may utilize, without limitation, a storage space/size value, a number of files, or any other appropriate measurement value. In one implementation, the excess capacity determination may utilize a range of values. For instance, when the primary content has a variable bit rate for video compression that allows the storage space required for the primary content to be variably selected in connection with the compression rate that is selected, then the excess capacity available for the secondary content will also vary in conjunction with the compression rate selected for the primary content.

Once the excess capacity that is available for the secondary content is determined, the secondary content to be stored on the storage medium is selected in operation 104 to fit within the excess capacity. In one implementation, the secondary content is selected based upon the available excess capacity on the storage medium. However, in other implementations, other considerations may play a role in the selection process, or may alternatively serve as the main factor during the selection process, where such other considerations may include the quantity of desired secondary content, the quality of the secondary content, the value of the secondary content, the price at which the storage medium containing the content will be sold, the playback device on which the storage medium is intended to work, the desired consumer experience, retailer needs, third party bandwidth sales, manufacturing constraints, scope and breadth of content, etc.

In some implementations where the considerations associated with the secondary content are the driving factor in allocating content, the storage conditions of the primary content can in turn be affected by the secondary content allocated for the excess capacity of the storage medium. For instance, it is possible to adjust the storage capacity required for the primary content by adjusting the fidelity of the primary content in order to accommodate the excess storage capacity required for the secondary content. The fidelity of the primary content can be adjusted by adjusting its compression rate, by editing the primary content, or otherwise altering the primary content so as to affect its required storage capacity. In some implementations, different codecs (e.g., MPEG2, MPEG4-2 and MPEG4-10, etc.) may be utilized depending upon the particular compression rates desired for either the primary or secondary content.

Once the secondary content is allocated for the excess capacity of the storage medium, the storage medium allocation for both the primary content and the secondary content is output in operation 106. This output may be stored in a memory or database, may be used to complete authoring of the storage medium (e.g., DVD authoring), may be communicated to a remote location or device, or otherwise used for storage medium creation purposes.

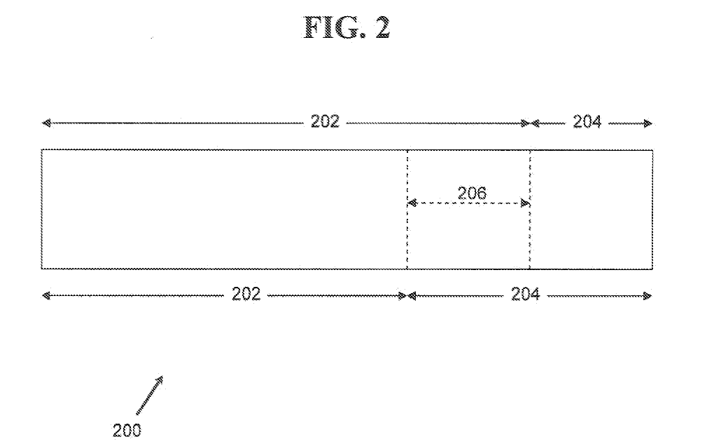

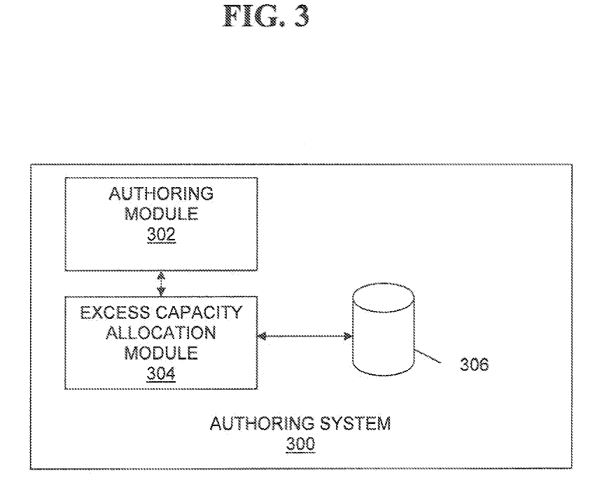

Referring now to FIG. 2, an example illustrating how the excess capacity determination may comprise a range of values is shown in the block schematic illustration of an exemplary storage medium 200. The storage medium includes a primary content storage region 202 and a secondary content storage region 204. The variably selectable compression rate for the primary content causes the size of the primary content storage region 202 to also vary in connection with the compression rate selected. In turn, the size of available excess capacity contained in the secondary content storage region 204 will likely vary inversely to the size of the primary content storage region 202. As indicated by dashed lines in FIG. 3, a portion 206 of the storage medium 200 may contain either primary content or secondary content, where portion 206 represents a variable range of values for the primary content and secondary content.

The various operations described above in connection with FIG. 1 can be performed in any order or simultaneously. Some or all of the various operations can be performed iteratively. The present system and method facilitates decisions for allocating storage medium capacity based on the various inputs it receives. Rather than using a “FIT” or “DOES NOT FIT” decision process where buffer regions are left unused, storage medium allocation decisions are made to better utilize the storage of content on the storage medium to its available capacity. In one aspect, the capacity allocation may comprise filling the entire storage capacity of the storage medium. In other aspects, the capacity allocation may fill less than the full storage capacity of the storage medium if considerations so dictate. Storage medium allocation decisions can take various considerations into account including, but not limited to, quality of the stored content, cost to produce, distribute and purchase the final product, manufacturing constraints, consumer experiences, retailer needs, advertising sales. In this manner, many of these considerations can serve to drive the selections that are made with respect to the storage conditions for the primary content (e.g., video compression rates) and/or the allocated secondary content.

In some implementations, the various operations performed in allocating excess capacity for additional content on a storage media are performed using a predetermined knowledge of the storage capacity of the storage medium. In other implementations, the storage capacity of the storage medium can be sensed or determined prior to performing these operation, or alternatively, a consumer can input or otherwise indicate the storage capacity of the storage medium that will be used to store the primary and secondary content. For example, if the consumer is downloading the primary or secondary content over the Internet or at a remote location (e.g. kiosk), the consumer can be queried to input the storage capacity and/or type of the storage medium being used to store the primary and secondary content, such that the excess capacity for the secondary content can be determined using the consumer's input storage capacity for the storage medium as a factor.

In some implementations, the excess capacity available for secondary content can be used for advertisements, trailers and/or marketing materials. The excess capacity can be sold to third parties in a variety of manners. One such manner would be one-off sales contract, where sales contracts could be based on, but not limited to, a per-unit basis, per-title basis, per-sku basis (e.g., titles sold only to specific stores), per unit volume basis, per-disc basis, per-retailer basis, per-production entity basis, per-talent basis, per-demographic basis, per unit bandwidth, etc. Excess capacity could alternatively be sold via output deals or by advance auctions. Advertising selections can optionally involve subject matter matching of certain primary content with secondary advertising content such that the subject matter of the secondary content is selected based on the expected or target audience of the subject matter of the primary content. Third parties could be provided with the option of offsetting the cost of the storage media to consumers for specific storage media containing the advertisements for those third parties, such that a consumer could pay varying amounts for storage media having the same primary content but different secondary content depending upon the particular advertising material included in the storage media. In one aspect, the advertising third party can be notified when a consumer views their advertisements or other secondary content that are selected to be included on the storage medium such as when the secondary content is an executable file or hyper link. Such notice of the timing and frequency of consumer viewing can be utilized as a basis for payment activity.

By making the excess capacity of the storage medium available to advertisers, a powerful marketing tool is provided. In one aspect, DVDs, especially those produced and marketed to sell entertainment content (e.g., motion pictures, television episodes), represent vast quantities of excess bandwidth capacity delivered to the consumer on a routine basis. This excess bandwidth is generally fungible on a per disc basis and its volume is bounded both by the need to meet compression standards for the entertainment content and the desire to include value added content on each disc to boost sales. The incremental cost of goods incurred to use or create surplus bandwidth on these DVDs is small, partly because there are no real-time delivery expectations (e.g., electronic bandwidth is priced both on usage and peak capacity needs while DVD bandwidth is priced based on opportunity costs). Additionally, DVD wholesalers use sophisticated forecasting and supply chain management techniques to carefully match supply and demand, lessoning overproduction of bandwidth in the aggregate. Additionally, the primary content on these DVDs, entertainment content, is distributed using existing relationships with physical media and consumer product aggregators.

In one aspect, the secondary content that is selected to be included in the excess capacity of the storage medium comprises only partial content or a portion of a file, where the remaining content or portion of the file must be obtained from another source or location. For instance, the secondary content may comprise a portion of a movie, which may or may not be related to the primary content, where the remaining portion of the movie must be obtained from another storage medium or downloaded.

Referring now to FIG. 3, a block diagram illustration of one embodiment of the system 300 for allocating excess capacity for additional content on a storage media is illustrated. The system 300 includes an authoring module 302, such as a DVD authoring tool, and an excess capacity allocation module 304. The excess capacity allocation module 304 operates according to the above-described method in conjunction with the operations of the authoring module 302. The system 300 also includes a secondary content database or library 306 containing the secondary content and its associated attributes, where the excess capacity allocation module 304 will access the secondary content database 306 to identify the secondary content that is eligible to be included in the excess capacity of the storage medium.

The system and method for allocating excess capacity for additional content on a storage media may be described in the general context of computer-executable instructions, such as program modules, being executed by a computer. Generally, program modules include routines, programs, objects, components, data structures, etc. that perform particular tasks or implement particular abstract data types. The system may also be practiced in distributed computing environments where tasks are performed by remote processing devices that are linked through a communications network. In a distributed computing environment, program modules may be located in both local and remote computer storage media including memory storage devices. The computer programs are stored in a memory medium or storage medium or they may be provided to a processing unit though a network or I/O bus.

In various embodiments, the system and method for allocating excess capacity for additional content on a storage media is operational in a DVD authoring infrastructure or with numerous other general purpose or special purpose computing system environments or configurations. In one implementation, the present system for allocating excess capacity on a storage medium includes at least one central processing unit (CPU) or processor. The CPU may include or be coupled to a memory, ROM or computer readable media containing the computer-executable instructions for generating and using fingerprints for integrity management. Computer readable media can be any available media that can be accessed by the system and includes both volatile and nonvolatile media, removable and non-removable media implemented in any method or technology for storage of information such as computer readable instructions, data structures, program modules or other data. Computer storage media includes, but is not limited to, RAM, ROM, EEPROM, flash memory, portable memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed. Combinations of any of the above should also be included within the scope of computer readable media. The computer readable media may store instructions and for data which implement all or part of the system described herein.

While the system and method have been described in terms of what are presently considered to be specific embodiments, the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method of allocating storage medium capacity, comprising:
determining storage conditions for primary content to be stored on a storage medium; and
allocating secondary content to be stored on the storage medium based on the primary content storage conditions and a storage capacity of the storage medium.

2. The method of claim 1, wherein the secondary content allocation comprises:
determining an excess capacity of the storage medium that exceeds a storage capacity required for the primary content and
selecting secondary content to occupy the excess capacity.

3. The method of claim 1, wherein the determined storage conditions for the primary content are affected by the allocated secondary content.

4. The method of claim 3, wherein the determined storage conditions for the primary content include a variable rate of compression for the primary content.

5. The method of claim 4, further comprising selecting a variable rate of compression for the primary content and allocating secondary content so as to occupy the available storage capacity of the storage medium.

6. The method of claim 5, wherein the rate of compression for the primary content is selected from a plurality of possible compression rates based on the allocated secondary content.

7. The method of claim 1, wherein the storage medium comprises an optical storage media.

8. The method of claim 1, wherein the storage medium comprises a DVD.

9. The method of claim 1 further comprising determining storage conditions for the primary content and allocating the secondary content at a final compilation and disc rendering stage in a DVD authoring process.

10. The method of claim 1, further comprising allocating the secondary content based upon at least one input selected from the group consisting of a number of secondary content files, compression rates of either the primary or secondary content, storage capacity available on the storage medium, amount of secondary content, value of secondary content, projected unit volume production for the storage medium, desired playback device for the storage medium and price of the storage medium.

11. The method of claim of claim 1, wherein the secondary content comprises advertisements.

12. A method of allocating space on a storage medium product comprising:
determining primary content to be stored on a storage medium product wherein the primary content includes certain storage conditions;
determining an excess capacity of the storage medium product that exceeds a storage capacity required for the primary content; and
allocating secondary content to be stored on the storage medium product based on the storage conditions of the primary content and product distribution considerations.

13. The method of claim 12 wherein the product distribution considerations include at least one of the following considerations selected from the group consisting of a number of secondary content files, performance quality of the primary or secondary content storage capacity available on the storage medium, quantity of secondary content, value of secondary content, projected unit volume production for the storage medium desired playback device for the storage medium and price of the storage medium.

14. A storage medium comprising:
primary content allocated to a first portion of the storage medium;
secondary content allocated to a second portion of the storage medium, wherein the selection of the secondary content is determined in part by characteristics of the primary content and/or characteristics of the first portion of the storage medium.

15. The storage medium of claim 14 wherein at least one of the characteristics of the primary content is determined in part by the selection of the secondary content.

16. The storage medium of claim 14 wherein the characteristics are selected from the group consisting of: compression rates the primary content, storage capacity consumed by the secondary content size of the first portion of the storage medium, desired playback device for the primary content and subject matter of the primary content.

17. A method of allocating storage medium capacity, comprising:
determining a storage capacity for a storage medium
allocating secondary content to be stored on the storage medium and determining storage conditions for the allocated secondary content; and
allocating primary content to be stored on the storage medium based on the secondary content storage conditions and the storage capacity of the storage medium.

18. The method of claim 17, wherein the primary content allocation comprises:
selecting primary content to be stored on the storage medium;
determining an excess capacity of the storage medium that exceeds a storage capacity required for the secondary content; and
adjusting the primary content to occupy the excess capacity.

19. The method of claim 18, wherein the primary content is adjusted by selecting a compression rate for the primary content that allows the primary content to occupy the excess capacity.
